(19) United States
(12) Patent Application Publication
(10) Pub. No.: US 2020/0165491 A1
(43) Pub. Date: May 28, 2020

(54) METHOD OF MAKING AN ADHESIVE CABLE-WRAP TAPE

(71) Applicant: CERTOPLAST TECHNISCHE KLEBEBÄNDER GMBH, Wuppertal (DE)

(72) Inventor: Thorsten MEIER, Duesseldorf (DE)

(21) Appl. No.: 16/619,497

(22) PCT Filed: Jun. 26, 2018
(86) PCT No.: PCT/EP2018/067144

§ 371 Date: Dec. 5, 2019

(30) Foreign Application Priority Data
Jun. 27, 2017 (DE) 10 2017 114 256.8

(51) Int. Cl. C09J 7/38; C09J 11/08; C09J 7/21

(52) U.S. Cl. CPC C09J 7/385; C09J 11/08; C09J 7/21; C09J 2205/102; C09J 2493/00; C09J 2400/263; C09J 2203/302; C09J 2433/00

(57) ABSTRACT

The invention relates to a method for producing an adhesive tape (1), in particular a wrapping tape for wrapping around cables in automobiles. A strip-shaped carrier (2) is provided with a UV cross-linkable adhesive coating (5). In addition to an acrylate-based pressure-sensitive adhesive with embedded photoinitiators, the adhesive coating (5) comprises at least one additive. The photoinitiators are activated for cross-linking by irradiation with a UV light source (6) emitting in the range of its activation wavelength. According to the invention, the additive has at least in the range of the activation wavelength of the photoinitiators an absorbance (E) of 0.1 to 0.7, preferably between 0.2 and 0.6.

The invention relates to a method of making adhesive tape, in particular a tape for wrapping cable in automobiles, according to which a substrate strip is provided with a UV-cross-linkable adhesive coating that comprises, in addition to an acrylate-based pressure-sensitive adhesive with embedded photoinitiators, at least one additive, and according to which the photoinitiators are activated for cross-linking through irradiation with a UV light source radiating in the range of their activation length. The photoinitiators that are incorporated into the adhesive coating can be copolymerized, mixed, or otherwise introduced into the adhesive coating.

A method having as described above is described for example in EP 1 548 080. It relates overall to a technical adhesive tape suitable for use in construction. For this purpose, a high specific weight per unit area of at least 100 g/m² is used for the adhesive coating. Especially effective adhesion is thus attained even on rough surfaces by these parameters.

US 2017/0081566 [U.S. Pat. No. 9,828,533] relates to UV-cross-linkable acrylates that, in addition to the pressure-sensitive adhesive, have additional photoinitiators and an additive that is a resin admixture. In addition, correspondingly equipped pressure-sensitive adhesive tapes, or PSA (pressure-sensitive adhesive) adhesive tapes, are described.

In addition to the acrylate-based pressure-sensitive adhesive with incorporated photoinitiators, UV-cross-linkable adhesive coatings typically also have an additive that is generally intended to increase adhesion to the substrate strip. This is especially true for nonpolar substrate surfaces. However, such additives may interfere with subsequent cross-linking. In fact, the substrate strip is typically first provided with the adhesive coating and then irradiated with the UV light source.

The UV light source primarily ensures that the photoinitiators are irradiated with the required UV dose in the range of their activation wavelength so that the desired cross-linking of the adhesive coating takes place. In fact, the photoinitiators incorporated in the acrylate-based pressure-sensitive adhesive ensure that the acrylate polymers are combined to form a relatively wide-meshed network.

In order not to jeopardize the cross-linking and consequently the activation of the photoinitiators, it is emphasized in the prior art in the context of a publication by BASF on the topic of “UV-Curable acrylic hot-melts for PSA's” with a publication date of 22 May 2001 that, for this reason, the additive to the pressure-sensitive adhesive must have no absorption capacity or practically no absorption capacity in the range of the relevant activation wavelength of the photoinitiators. It is purported that sufficient UV-C light is otherwise unable to penetrate into the adhesive coating in the particular case in order to ensure the above-described cross-linking over the entire surface. In the present case, “UV-C light” refers to high-frequency UV radiation that is located in the wavelength range from 200 nm to 280 nm. In contrast, middle UV or UV-B radiation extends in a wavelength range from 280 nm to 315 nm. Near UV light, or black light (W-A), on the other hand, corresponds to the wavelength range from 315 nm to 380 nm. As a consequence of this specification, only those additives besides the acrylate-based pressure-sensitive adhesive with the incorporated photoinitiators that have practically no absorbance in the range of the activation wavelength have been found to be expedient.

One such commercially available product is marketed under the name Foral 85 or Foral 105. Both of these are abietic ester-based resin blends, provided that they are hydrogenated and consequently have the required transmissibility in the range of the activation wavelength. One drawback of the above-described resin admixtures is their price that can sometimes even exceed that of the actual acrylate-based pressure-sensitive adhesive with the incorporated photoinitiators. It is in this regard that the invention as a whole aims to provide a remedy.

The object of invention is to further develop such a method of making an adhesive tape such that the manufacturing costs are substantially reduced.

In order to attain this object, a method is provided according to claim 1.

In the context of the invention, a certain class of additives will first be addressed and claimed that are characterized by a certain transmissibility in the UV range. In fact, the absorption indicated by the symbol E is the reduction in the intensity of the light measured, for example, in a photometer when a corresponding sample of the additive passes through, which is also referred to as sample transmissibility. In contrast to the prior art, for example in the context of the abovementioned article “UV-curable acrylic hot-melts for PSA's,” additives or resin admixtures that are provided with a certain absorption in the range of the activation wavelength of the photoinitiators in the pressure-sensitive adhesive are expressly allowed according to the invention. This is expressed by the data for the absorption in the range between 0.1 and 0.7.

By contrast, the absorption of, say, Foral 85 in the range of a typical activation wavelength of photoinitiators between 250 nm and 260 nm is close to zero. However, the invention is based on the insight that the UV light source irradiates the adhesive coating with a UV dose of greater than 15 mJ/cm², particularly with a UV dose of greater than 20 mJ/cm². As a rule, the UV dose is in the range of 50 mJ/cm² and, in particular, from 150 mJ/cm² up to 500 mJ/cm². Preferably, irradiation doses in the range from 200 mJ/cm² to 400 mJ/cm² can be achieved with the aid of the UV light source.

All of this works especially favorably if an LED-based light source is used as the UV light source. Unlike the mercury vapor lamps that are typically used in practice, with their sharp spectral lines in the UV range, emission spectra of UV LEDs are characterized by a much broader spectral distribution. This enables more effective cross-linking to be achieved overall even with the same UV dose. This holds true at least for the range of 250 nm to 260 nm, for example, that is especially relevant for the cross-linking, when an acrylate adhesive such as that bearing the trade name “AcResin” is used, for example.

Conversely, it is possible, particularly with an LED-based UV source, for the photoinitiators incorporated into the acrylate-based pressure-sensitive adhesive to still be properly activated even if a portion of the UV radiation is absorbed by the additive. That is, particularly by making use of an LED-based UV light source, additives can also be added to the acrylate-based pressure-sensitive adhesive with the incorporated photoinitiators that have nonnegligible absorption in the range of the activation wavelength in order to increase the adhesion to the substrate strip. Since such additives or resin admixtures for increasing the adhesion to the substrate strip can be manufactured at substantially lower cost than the aforementioned reference products Foral 85 or Foral 105, for example, the tapes produced in this manner can be made with significant cost advantages over the prior art. Herein lie the fundamental advantages.

According to an advantageous embodiment, the resin admixture is based on a partially hydrogenated abietic acid ester. Due to the partial hydrogenation, i.e. the only partial addition of hydrogen, such resin admixtures can be prepared with significant cost advantages compared to fully hydrogenated products such as Foral 85 or Foral 105. At the same time, such resin admixtures that are based on a partially hydrogenated abietic acid ester are distinguished by their complete compatibility with acrylate polymers. Likewise, they have a high temperature resistance, which is why they are especially good for use in the manufacture of wrapping tapes for wrapping cables in automobiles, where elevated temperatures of 60° C., 80° C., and more are observed in practice. In fact, service temperatures up to 150° C. are required in this context. The overload temperature to be tested is even 200° C. (for 6 hours). At the same time, their cohesiveness ensures that the adhesive coating that is provided with the corresponding additive adheres perfectly to nonpolar substrate strips, thus enabling the coating to be successfully applied easily and quickly. For this purpose, the additive is usually present in the adhesive coating in a grammage of at least 5 wt % or at least 10 wt %. In addition, an upper limit for the additive of 30 wt % and in particular up to 40 wt % in the adhesive coating is regularly put into practice.

According to the invention, an activation wavelength of between 250 nm and 260 nm is used in this connection. However, it is also possible to work with activation wavelengths of up to 320 nm, depending on the photoinitiator used. That is, a range of the activation wavelength that is dependent on the respective photoinitiator is conceivable here that ranges from 250 nm to 320 nm, preferably from 250 nm to 300 nm, and very especially preferably from 250 nm to 260 nm. This specified range of the activation wavelength is recommended because the pressure-sensitive adhesive used is usually a UV-reactive, solvent-free acrylic acid ester copolymer with respectively incorporated photoinitiators. In fact, such pressure-sensitive adhesives are available under the brand name acResin, for example, and are offered by BASF. Of course, this is only for the sake of example.

The adhesive coating is applied to the substrate strip with an application weight of greater than 15 g/cm², particularly of greater than 20 g/cm², and preferably of greater than 50 g/cm². At maximum, the coating weight is 200 g/m², and especially preferably up to 90 g/m². The application is generally carried out in the form of a hot-melt adhesive coating at temperatures between about 120° C. and 140° C. and preferably up to a temperature of 150° C. After being applied, the adhesive coating is cross-linked with the aid of the UV light source. Decisive for the cross-linking is the wavelength range below about 340 nm, particularly the wavelength range between 220 nm and 280 nm. In the described embodiment of the hot-melt adhesive AcResin, emission wavelengths of the UV light source of between 250 nm and 260 nm are primarily required.

The output of the UV light source is in the range from 100 W/cm to 200 W/cm. The flow rate of the adhesive-coated substrate strip beneath the UV light source can for example be set between 10 m/min and 100 m/min or more.

According to the invention, the photoinitiators are usually present in the adhesive coating at a grammage of at least 0.05 wt %. Preferably, a grammage of from 0.2 wt % to 5 wt % and particularly between 0.2 wt % and 2 wt % is observed. For the additive or the resin admixture in the adhesive coating, the invention provides for a grammage of up to 30 wt % and up to 40 wt % in the adhesive coating. The additive constitutes at least 5 wt % of the adhesive coating. In addition, photoinitiators can be used in this context such as those that are described in principle in WO 2016/186877 [US 2018/0327640] and, in particular, in DE 695 15 310 [U.S. Pat. No. 6,245,922].

In principle, the substrate strip can be any conceivable substrate, such as a paper- or film-based substrate, for example. Especially preferably, textile fabrics are used here that are provided with a weight per unit area of between 50 g/m² and 250 g/m². Preferably, the weight per unit area is in the range between 15 g/m² and, particularly, 20 g/m² up to 250 g/m². Especially preferably, the weight per unit area is in the range between 70 g/m² and 200 g/m². Among the conceivable textile fabrics, nonwoven fabrics, particularly polyester nonwovens, but also woven fabrics, particularly polyester fabrics, polyamide fabrics, and mixed forms have been found to be especially advantageous.

A method of making this adhesive tape is thus characterized by particular cost advantages over the prior art. These cost advantages are primarily observed due to the fact that a resin admixture is used as part of the adhesive coating in order to increase the adhesion to the substrate strip and exhibits nonnegligible absorption in the range of the activation wavelength that is relevant for the photoinitiators. In fact, an absorption of 0.1 to 0.7 is observed for the additive in the range of the activation wavelength of the photoinitiators, which is significantly above comparative values of previously used resin admixtures such for example as Foral 85. As a result, cost-effective additives can be used that are typically prepared based on an only partially hydrogenated abietic acid ester. This significantly reduces production costs. Herein lie the fundamental advantages.

The invention is explained in further detail below with reference to a schematic drawing that illustrates only one exemplary embodiment:

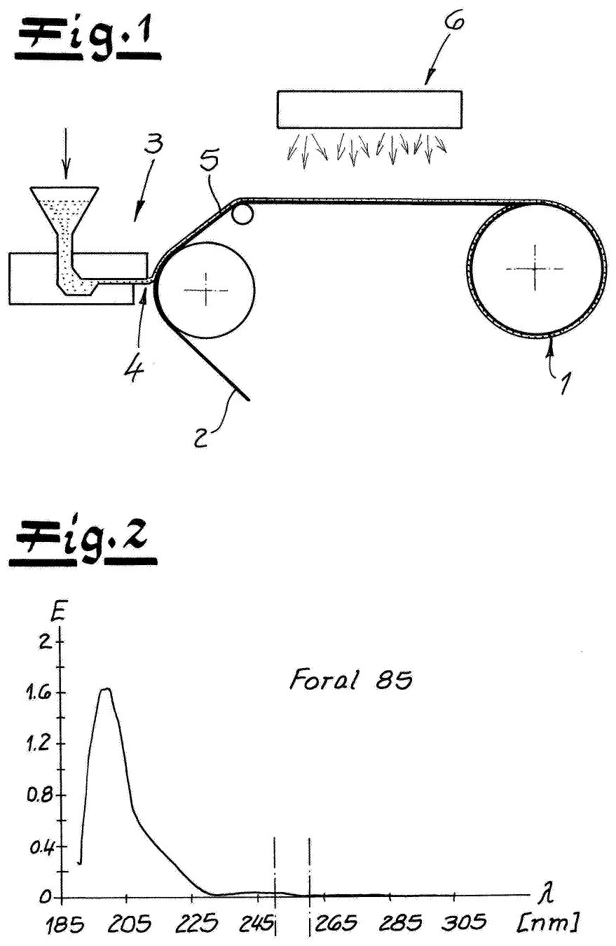

FIG. 1 is a schematic view of an apparatus for carrying out the method according to the invention,

FIG. 2 is a graph of an absorption spectrum or the measured absorption E over the wavelength for a resin admixture that is frequently used in practice (Foral 85),

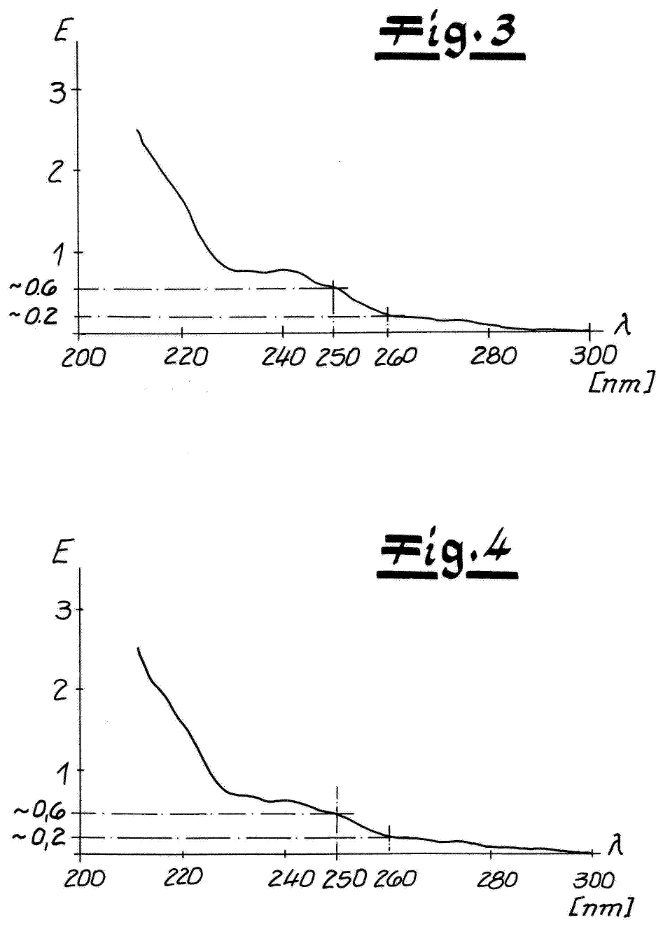

FIG. 3 is a graph of an alternative additive 1 that is used in the context of the invention and its absorption spectrum or absorption E over the wavelength,

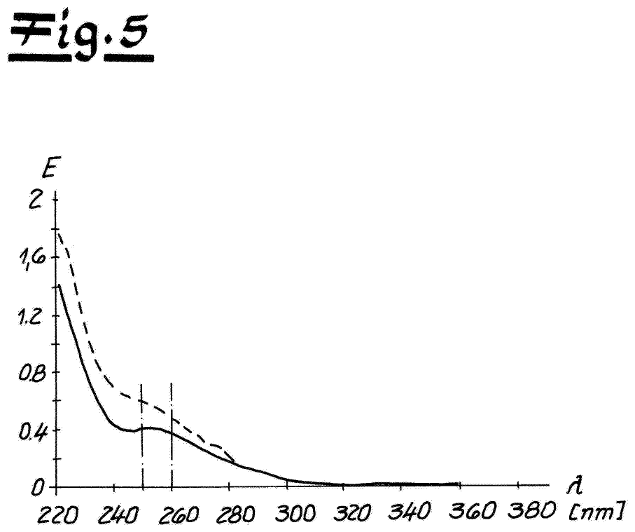

FIG. 4 is a graph like FIG. 3 for an additive 2, and

FIG. 5 is a graph of an absorption spectrum or, again, the absorption over the wavelength in consideration of the acrylate-based pressure-sensitive adhesive with the incorporated photoinitiators without resin admixture (solid line) and with resin admixture (dashed line).

FIG. 1 shows an apparatus with the aid of which an adhesive tape 1 can be manufactured. For this purpose, a substrate strip 2 is fed to a coater 3 for hot-melt adhesive. In the coater 3 for the hot-melt adhesive, the hot-melt adhesive is at a temperature of about 100° C. to 150° C. and can be applied to the substrate strip 2 being moved past the nozzle 4 via an output-side nozzle 4 of the coater 3, thereby coating the substrate strip 2.

The substrate is a substrate strip 2 that is embodied as a textile fabric and has a weight per unit area of between 50 g/m² and 250 g/m². After coating the substrate strip 2 with an adhesive coating 5 in this manner, the adhesive coating 5 is cross-linked by a UV light source 6 that is above the continuously coated substrate strip 2. It will be readily understood that the adhesive coating 5 is provided on the side of the substrate strip 2 facing the UV light source 6. The light source 6 is an LED-based light source. In fact, a large number of LEDs or UV-LEDs are implemented here. In principle, however, the UV light source 6 can also make use of for example a mercury vapor lamp. That is not shown, however.

The substrate strip 2 that has been provided with the adhesive coating 5 moves beneath the UV light source 6 at a speed of from 10 m/min to 100 m/min or more. The adhesive coating 5 is irradiated by the UV light source 6 at a UV dose in the range from 150 mJ/cm² to 500 mJ/cm². The UV light source 6 emits, inter alia or largely, in the range of the activation wavelength for the photoinitiators that are incorporated into the adhesive coating 5. The activation wavelength lies primarily in the range between 250 nm and 260 nm but can reach up to 320 nm, depending on the photoinitiator used.

The adhesive coating 5 has at least one additive in addition to an acrylate-based pressure-sensitive adhesive with the incorporated photoinitiators. As an additive, the invention makes use of a resin admixture based on a merely partially hydrogenated abietic acid ester. After the substrate strip 2 has been provided with the adhesive coating 5, the adhesive tape 1 manufactured in this manner can be wound up or cut in the longitudinal direction if a fabric web is being fed to the coater 3 here as the substrate strip 2. This is known in detail.

FIG. 2 shows an absorption spectrum of an additive or resin admixture that is used in practice and according to the prior art. This is an abietic acid ester-based resin that has been hydrogenated and is sold under the trade name Foral 85. It can be seen that, in the range of the activation wavelength between 250 nm and 260 nm that is relevant for the activation of the photoinitiators within the adhesive coating 5 and represented by corresponding limits, the absorption E is virtually zero, so the known resin admixture Foral 85 according to the prior art is practically completely transmissive or transparent in this range and nonabsorptive.

In contrast, the resin admixtures of the invention shown in FIGS. 3 and 4 that are based on the only partially hydrogenated abietic acid ester have values for the absorption E of approximately 0.6 at 250 nm and approximately 0.2 at 260 nm in the relevant range of the activation wavelength between 250 nm and 260 nm. FIG. 3 illustrates the additive 1 or the absorption E thereof over the wavelength. FIG. 4 shows a diagram that is comparable to that of FIG. 3 for the additive 2. That is, the relevant additive 1 or 2 according to the invention is provided with an absorption E of 0.1 to 0.7 or 0.2 to 0.6 in the range of the activation wavelength between 250 nm and 260 nm of the photoinitiators of the adhesive coating 5.

Finally, FIG. 5 shows a comparison of the UV-cross-linkable acrylate-based pressure-sensitive adhesive with the incorporated photoinitiators and without resin admixture (solid) with the same pressure-sensitive adhesive in consideration of the inventive resin admixture according to additive 1 (dashed line). It can be seen here again that, in the relevant range of the activation wavelength between 250 nm and 260 nm, the absorption and, consequently, the absorption has increased compared to the situation without resin admixture due to the additive or the resin admixture based on the only partially hydrogenated abietic acid ester. Nevertheless, proper cross-linking of the incorporated photoinitiators in the pressure-sensitive adhesive 5 continues to be observed and achieved unchanged in the context of the invention. This can be attributed substantially and primarily to the emission spectrum of the UV LEDs used, on the one hand that is for example more homogeneous compared to mercury vapor lamps and to the slightly increased UV dose in comparison to the prior art according to EP 1 548 080 B1 on the other hand.

Additives 1 and 2 are each rosin admixtures based on a partially hydrogenated abietic acid ester. Additive 1 corresponds to the product YT311 from the company Yser, whereas additive 2 denotes the product YT321 from that company.

1. A method of making an adhesive tape, the method comprising the steps of:
providing a substrate strip with a UV-cross-linkable adhesive coating having an application weight of from 15 g/m² to 250 g/m², the adhesive coating comprising
an acrylate-based, pressure-sensitive adhesive with incorporated photoinitiators having an activation wavelength between 250 nm and 320 nm and present in the adhesive coating in a grammage of from 0.05 wt % to 5 wt %, and
an additive embodied as a resin admixture present in the adhesive coating in a grammage of up to 40 wt % and having an absorption of 0.1 to 0.7 at least at the activation wavelength of the photoinitiators, and
activating the photoinitiators for cross-linking by irradiation with a UV light source that emits in the range of the activation wavelength of the photoinitiators.

2. The method according to claim 1, wherein the additive has an absorption E between 0.2 and 0.6 in the range of the activation wavelength of the photoinitiators.

3. The method according to claim 1, wherein the UV light source irradiates the adhesive coating with a dose of from 15 mJ/cm² to 400 mJ/cm².

4. The method according to claim 1, wherein an LED-based UV light source is used.

5. The method according to claim 1, wherein the additive is applied in order to increase the adhesion to the substrate strip.

6. The method according to claim 1, wherein the additive embodied as a resin admixture is based on a partially hydrogenated abietic acid ester.

7. The method according to claim 1, wherein the substrate strip is embodied as a textile fabric with a weight per unit area of between 15 g/m² and 250 g/m².

8. The method according to claim 1, wherein the photoinitiators are provided in the adhesive coating in a grammage of from 0.2 wt % to 5 wt %.

9. The method according to claim 1, wherein the additive is present in the adhesive coating in a grammage of at least 5 wt % and up to 40 wt %.
